(19) United States
(12) Patent Application Publication
(10) Pub. No.: US 2026/0124752 A1
(43) Pub. Date: May 7, 2026

(54) METHOD FOR AUTOMATICALLY PLANNING AN OPTIMAL TRAJECTORY FOR A ROBOT DEVICE AND ROBOT CONTROL SYSTEM FOR A ROBOT DEVICE

(71) Applicant: ABB Schweiz AG, Baden (CH)

(72) Inventors: Debora Clever, Zwingenberg (DE); Florian Stuhlenmiller, Ladenburg (DE); Bjoern Matthias, Bad Schönborn (DE); Arne Wharburg, Weiterstadt (DE); Nima Enayati, Mannheim (DE); Christoph Byner, Mannheim (DE); Silke Klose, Bensheim (DE)

(73) Assignee: ABB Schweiz AG, Baden (CH)

(21) Appl. No.: 19/427,269

(22) Filed: Dec. 19, 2025

Related U.S. Application Data
(63) Continuation of application No. PCT/EP2023/066839, filed on Jun. 21, 2023.

(51) Int. Cl. B25J 9/16

(52) U.S. Cl. CPC B25J 9/1666; B25J 9/1653; B25J 9/1676

(57) ABSTRACT

A method for automatically planning an optimal trajectory for a robot device includes obtaining a safety-related information comprising a safety zone having a safety condition for a movement behavior of the robot device that is supervised by a safety controller; obtaining a movement-related target parameter of the robot device that will be optimized for an operation of the robot device; and generating by a motion planner module the optimal trajectory for the robot device by incorporating the at least one safety-related information and the movement-related target parameter, wherein the generated optimal trajectory defines an optimal movement of the robot device that respects the safety condition and the movement-related target parameter.

### CROSS-REFERENCE TO RELATED APPLICATIONS

The instant application claims priority to International Patent Application No. PCT/EP2023/066839, filed Jun. 21, 2023, which is incorporated herein in its entirety by reference.

### FIELD OF THE DISCLOSURE

The present disclosure generally relates to a method for automatically planning an optimal trajectory for a robot device and a robot control system for a robot device.

### BACKGROUND OF THE INVENTION

In prior art, trajectory planning and generating for a robot device usually respects a predefined safety configuration or safety information that is statically implemented in a safety controller. This means that during planning of the trajectory of the robot device, predefined safety conditions or safety constraints as part of the safety configuration are respected in such a manner that for example, a speed limit corresponding to the predefined safety configuration is respected when planning the trajectory of the robot device.

During operation of the robot device, in case the robot devices violates a predefined safety condition, the motion controller can adapt the speed pre-emptively to avoid violation of a predefined safety condition and thereby a protective stop being triggered by the safety controller.

Controlling the motion behavior of the robot device in such a manner has many disadvantages when operating the robot device regarding process time, operation or performance costs etc. and is the result, because safety-related information of the safety-controller or the supervision control system is strictly separated from trajectory planning module of the robot device.

This classical approach has worked in the past, when safety-related information is not changing. However, due to dynamically changing environments of the robot device, increased information regarding the safety configuration of the robot device is also dynamically changing and thus, needs to be considered when automatically planning the trajectory of a robot device.

### BRIEF SUMMARY OF THE INVENTION

The present disclosure generally describes an improved concept for automatically planning an optimal trajectory for a robot device. In a first aspect, there is provided a method for automatically planning an optimal trajectory for a robot device comprising: obtaining, from a safety controller module, at least one safety-related information comprising at least one safety zone of the robot device including at least one safety condition for a movement behaviour of the robot device that is supervised by the safety controller during an operation of the robot device; obtaining a movement-related target parameter of the robot device that will be optimized for an operation of the robot device; and generating, by the motion planner module, the optimal trajectory for the robot device by incorporating the at least one safety-related information and the movement-related target parameter, wherein the generated optimal trajectory defines an optimal movement of the robot device that respects the safety condition and the movement-related target parameter.

### BRIEF DESCRIPTION OF THE SEVERAL VIEWS OF THE DRAWING(S)

FIG. 1 is a schematic flow-diagram of a method in accordance with the present disclosure.

FIG. 2 is a diagram of a robot control system according to an embodiment of the present disclosure.

### DETAILED DESCRIPTION OF THE INVENTION

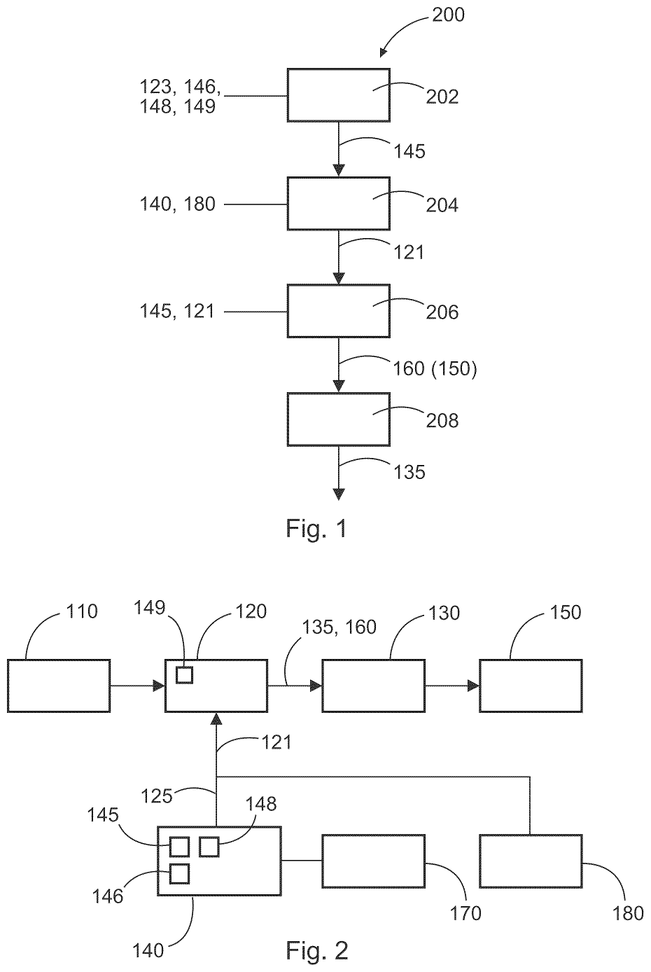

FIG. 1 illustrates a schematic flow-diagram of a method 200 for automatically planning an optimal trajectory 160 for a robot device 150.

In a first step 202, from a safety controller module 140, at least one safety-related information 145 is obtained comprising at least one safety zone information 148 of the robot device 150 including at least one safety condition 146 for a movement behavior of the robot device 150 that is supervised by the safety controller 140 during an operation of the robot device 150. In this respect, it should be noted that the safety condition 146 only holds true in a very spatial area, which is defined as a safety zone which is part of the safety zone information 148.

Optionally, the step of obtaining 202 at least one safety-related information 145 is based on an environment-based parameter 123 allowing to enable or disable usage of the at least one safety-related condition 146.

In a second step 204, a movement-related target parameter 121 of the robot device 150 is obtained that will be optimized for an operation of the robot device 150. In this respect, it should be noted that here it should be only defined for which movement-related parameter the motion of the robot device 150 should be optimized. The movement-related target parameter 121 is at least one of cycle time, energy consumption of the robot device 150. The steps 202 and 204 may also be performed in a parallel manner and/or in a reversed order.

In a third step 206, by the motion planner module 120, the optimal trajectory 160 is generated for the robot device 150 by incorporating the at least one safety-related information 145 and the movement-related target parameter 121, wherein the generated optimal trajectory 160 defines an optimal movement of the robot device 150 that respects the safety condition 146 included in the safety zone information 148 and the movement-related target parameter 121.

Optionally, the step of generating 206 the optimal trajectory 160 may also be based on a starting trajectory that is optimized in respect of the at least one safety condition 146 and/or in respect of the at least one movement-related target parameter 121.

Optionally, the method 200 comprises the step of generating 208 a corresponding motion instruction 135 for a motion control module 130 of the robot device 150 based on the generated optimal trajectory 160.

FIG. 2 illustrates a schematic example of a robot control system 100 for automatically planning an optimal trajectory 160 for a robot device 150, according to an embodiment. The core components of the robot control system 100 are a motion planner module 120, a motion control module 130 and a safety controller module 140. Each of the modules is described in the following in a detailed way with reference to FIG. 1.

The safety controller module 140 of the robot control system 100 is configured to provide at least one safety-related information 145 comprising at least one safety zone information 148 of the robot device 150 including at least one safety condition 146 for a movement behavior of the robot device 150 that is supervised by the safety controller module 140 during an operation of the robot device 150. Further, in this respect it should be noted that the supervision function of the safety controller module 140 means that the safety controller module 140 observes the behavior of the robot device 150 and decides whether to let motion continue. The means to stop motion of robot device 150 may mean to disconnect power to the motion control.

The motion planner module 120 of the robot control system 100 is connected to the safety controller module 140 via a communication interface 125. The motion planner module 120 is further configured to receive at least one movement-related target parameter 121 of the robot device 150 that is optimized for the operation of the robot device 150. Further, the motion planner module 120 is configured to generate an optimal trajectory 160 for the robot device 150 by incorporating the at least one safety-related information 145 and the movement-related target parameter 121. However, this parameter 121 must not necessarily come from the safety controller module 140, alternatively, this information 121 could also be a user input and a choice of criterion which the user wants to optimize.

Optionally, as depicted in FIG. 2, the motion planner module 120 may be connected to or may incorporate a program interpretation module 110. The program interpretation module 110 interprets program commands that provide the basic instructions for the execution of the intended application task of the robot device, including target tool positions of the robot device which are provided to the motion planner module 120.

The motion control module 130 of the robot control system 100 is configured to control the movement of the robot device 150 based on the generated optimal trajectory 160. For this, a corresponding motion instruction 135 is generated accordingly. The robot device 150 may comprise the robot control system 100 or may be linked to it.

Optionally, as can be seen in FIG. 2, the at least one safety-related information 145 is accessible at least partly via a communication interface 125 between the safety controller module 140 and the motion planner module 120 and/or is provided by the safety controller 140 to an external device 170 connected to the motion planner module 120.

Optionally, the safety condition 146 is related to at least one of a motor-related parameter, a joint-related parameter, task-space related parameter of the robot device 150.

Optionally, the at least one safety zone is approximated by a geometric shape information 149, wherein the geometric shape information 149 is transformed into a quantitative representation suitable for algorithmic use and that is suitable for optimizing the trajectory 160. The geometric shape information 149 may be provided by an expert programming the robot control system or may be automatically generated by the robot control system 100. Further the geometric shape information 149 may include information of a surface of a relevant safety zone, e.g. a cuboid shape, a sphere shape etc.

As further indicated in FIG. 2, the movement-related target parameter 121 of the robot device 150 may optionally be provided by the safety controller module 140 and/or by an input device 180, as indicated in FIG. 2. The input device 180 may be an additional external device that is connected via an interface, e.g. the interface 125, to the motion planner module 120.

In the sense of the present invention, optimizing the obtained movement-related target parameter of the robot device for an operation of the robot device means that an optimality for an operation of the robot device is defined.

In other words, an important aspect behind the present invention is that the generated optimal trajectory for the robot device defines an optimal movement of the robot device in which a predefined safety condition and a movement-related target parameter of the robot device are harmonized or coordinated to each other in order to find the optimal trajectory for the robot device.

Therefore, the optimal trajectory for the robot device is generated in respect of a predefined target criteria—a movement—related target parameter of the robot device, e.g. cycle time, energy consumption limit of the robot device, wherein always a safety-related information that respects safety supervision of the safety controller is considered as well. In this way, an optimal trajectory for the robot device can be generated that considers or respects what is admissible and is not admissible in terms of safety aspects that is required by the safety controller.

In this way, the present invention overcomes an urgent problem identified in the prior art, in which safety control and motion control of a robot device are strictly separated from each other. The present invention solves this problem by providing a new approach in which the safety control and the motion control of the robot device are connected by a unidirectional channel or a unidirectional communication link to exchange information for the sake of finding an optimal and feasible trajectory for the robot device.

The communication link is unidirectional in that the motion planning module can receive information from the safety control module, but not vice versa. The reason for this is that faulty information from the motion planning module to the safety control module could compromise the safety of the application, for example, by an automatic transfer from safety settings into the motion planner module safety constraints which are reformulated as mathematical description are considered in the trajectory planning.

Hence, the present invention provides an advantageous solution for handling position-dependent/zone-based safety conditions or safety constraints in this context.

Embodiments in accordance with the present disclosure present various advantages. If a tool for automatic motion planning is in place already, safety constraints can be considered without any additional effort from the user—ease-of-use. Feasible and collision-free trajectories for the robot device can be generated in an efficient and automatic manner instead of manually adapting trajectory points during the programming phase. Improved user-experience when operating the robot device. Finding an optimal path and velocity of the robot device at the same time instead of only adapting speed on a given or programmed motion path of the robot device (which is state of the art) resulting in an improved performance and efficiency of controlling the robot device.

A further advantage is that contrary to existing solutions in prior art the static safety configuration information stored in the safety controller is now used during runtime of the robot device. Making this static safety configuration information available in a motion plan for the robot device and for runtime use of the robot device is one important aspect.

Another important aspect is that it becomes possible to use safety sensor information, which is indeed dynamically changing, during runtime in the motion planning phase. So the basic aspects of the present invention can be summarized in the following way: Use of static safety configuration information in motion plan of the robot device. Such use only requires reading this information once at the beginning of the motion process of the robot device.

In prior art, dynamic safety information is not available for motion planning of the robot device due to lack of communication link between the safety controller and the motion planning module. In the present invention, however, such a real-time communication link between the safety controller and the motion planning module is implemented. This allows the motion planning module to consult, in real-time, the static and dynamic safety information in the safety controller. This includes all safety I/O signals and safety-related measurement values that can change during a running application.

Therefore, the present disclosure addresses and solves the following problems in the aforementioned manner: For motion planning responsiveness to static safety-related obstacles, make available static safety information to the motion planning module, at application start and optionally at any time during runtime. For motion planning responsiveness to dynamic safety-related conditions, make available dynamic safety information to the motion planning module during runtime.

According to an example, the at least one safety-related information is accessible at least partly via a communication interface between the safety controller module and the motion planner module and/or is provided by the safety controller to an external device connected to the motion planner module. In this way, the safety-related information is transmitted in an efficient manner to the motion planner module allowing to consider different application scenarios.

According to an example, the safety condition is related to at least one of a motor-related parameter, a joint-related parameter, task-space related parameter of the robot device. In this way, the generated trajectory for the robot device is more accurate in respect of changing or adapted application scenarios of the robot device. This may also include changing environments in which collision-free motion plans are required to protect from collisions with an installed periphery (which might move) and to protect from collisions with persons (which very likely move).

According to an example, the at least one safety zone is approximated by a geometric shape information, wherein the geometric shape information is transformed into a quantitative representation suitable for algorithmic use and that is suitable for optimizing the trajectory. In this way, a better trajectory for the robot device or to be more specific, the robot manipulator of the robot device, can be generated that is easily adaptable to changing application scenarios.

According to an example, the step of generating the optimal trajectory is based on a starting trajectory that is optimized in respect of the at least one safety condition and/or in respect of the at least one movement-related target parameter. In this way, the process of generating an optimal trajectory for the robot device can be conducted in a more efficient manner considering already existing trajectory information.

According to an example, the step of obtaining at least one safety-related piece of information is based on an environment-based parameter allowing to enable or disable usage of the at least one safety-related condition. In this way, generating the optimal trajectory can be made more flexible in terms of changing application scenarios for the robot device.

According to an example, the movement-related target parameter of the robot device is provided by the safety controller module and/or by an input device. In this way, generating the optimal trajectory for the robot device is streamlined and made more flexible when the application scenario for the robot device is changing.

According to an example, the movement-related target parameter is at least one of a speed, a cycle time, energy consumption limit of the robot device. In this way, the trajectory for the robot device can be planned in a more efficient manner respecting different application scenarios for the robot device.

According to an example, the step of generating a corresponding motion instruction for a motion control module of the robot device is based on the generated optimal trajectory.

In a second aspect of the present invention, a robot control system for automatically planning an optimal trajectory for a robot device is provided, comprising: a safety controller module that is configured to provide at least one safety-related information comprising at least one safety zone of the robot device including at least one safety condition for a movement behavior of the robot device that is supervised by the safety controller during an operation of the robot device; a motion planner module that is connected to the safety controller module via a direct link interface, wherein the motion planner module is further configured to receive at least one movement-related target parameter of the robot device that is optimized for the operation of the robot device, and wherein the motion planner module is configured to generate an optimal trajectory for the robot device by incorporating the at least one safety-related information and the movement-related target parameter; and a motion control module that is configured to control the movement of the robot device based on the generated optimal trajectory.

In a third aspect, a robot device is provided comprising the robot control system of the second aspect. In a fourth aspect, a computer is provided comprising a processor configured to perform the method of the preceding aspect. In a fifth aspect, there is provided a computer program product comprising instructions which, when the program is executed by a computer processor, causes the computer to perform the method of any of the first and second aspects. In a sixth aspect, a machine-readable data medium and/or download product containing the computer program of the fifth aspect.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCE SIGNS

100 Robot control system
110 Program interpretation module
120 Motion planner module
121 Movement-related target parameter
123 Environment-based parameter
125 Communication/data interface
130 Motion control module
135 Motion instruction
140 Safety controller module
145 Safety-related information
146 Safety condition
148 Safety zone information
149 Geometric shape information
150 Robot device
160 Optimal trajectory
170 External device
180 Input device
200 Method
202 Obtaining
204 Obtaining
206 Generating
208 Generating

What is claimed is:

1. A method for automatically planning an optimal trajectory for a robot device, comprising:
obtaining from a safety controller module at least one safety-related information comprising at least one safety zone information of the robot device including at least one safety condition for a movement behavior of the robot device that is supervised by the safety controller during operation of the robot device;
obtaining a movement-related target parameter of the robot device that will be optimized for an operation of the robot device; and
generating by the motion planner module the optimal trajectory for the robot device by incorporating the at least one safety-related information and the movement-related target parameter, wherein the generated optimal trajectory defines an optimal movement of the robot device that respects the safety condition and the movement-related target parameter.

2. The method according to claim 1, wherein the at least one safety-related information is accessible at least partly via a communication interface between the safety controller module and the motion planner module and/or is provided by the safety controller to an external device connected to the motion planner module.

3. The method according to claim 1, wherein the safety condition is related to at least one of a motor-related parameter, a joint-related parameter, task-space related parameter of the robot device.

4. The method according to claim 1, wherein the at least one safety zone is approximated by a geometric shape information, wherein the geometric shape information is transformed into a quantitative representation suitable for algorithmic use and that is suitable for optimizing the trajectory.

5. The method according to claim 1, wherein generating the optimal trajectory is based on a starting trajectory that is optimized in respect of the at least one safety condition and/or in respect of the at least one movement-related target parameter.

6. The method according to claim 1, wherein obtaining at least one safety-related information is based on an environment-based parameter that allows enabling or disabling usage of the at least one safety-related condition.

7. The method according to claim 1, wherein the movement-related target parameter of the robot device is provided by the safety controller module and/or by an input device.

8. The method according to claim 1, wherein the movement-related target parameter is at least one of, a cycle time, or an energy consumption of the robot device.

9. The method according to claim 1, further comprising generating a corresponding motion instruction for a motion control module of the robot device based on the generated optimal trajectory.

10. A robot control system for automatically planning an optimal trajectory for a robot device, comprising:
a safety controller module configured to provide at least one safety-related information comprising at least one safety zone of the robot device including at least one safety condition for a movement behavior of the robot device that is supervised by the safety controller during an operation of the robot device;
a motion planner module connected to the safety controller module via a communication interface, wherein the motion planner module is further configured to receive at least one movement-related target parameter of the robot device that is optimized for the operation of the robot device, and wherein the motion planner module is configured to generate an optimal trajectory for the robot device by incorporating the at least one safety-related information and the movement-related target parameter; and
a motion control module configured to control a movement of the robot device based on the generated optimal trajectory.

11. A computer program product comprising instructions which, when the computer program is executed by a computer processor, causes the computer to perform a method for automatically planning an optimal trajectory for a robot device, comprising:
Instructions for obtaining from a safety controller module at least one safety-related information comprising at least one safety zone information of the robot device including at least one safety condition for a movement behavior of the robot device that is supervised by the safety controller during operation of the robot device;
instructions for obtaining a movement-related target parameter of the robot device that will be optimized for an operation of the robot device; and
instructions for generating by the motion planner module the optimal trajectory for the robot device by incorporating the at least one safety-related information and the movement-related target parameter, wherein the generated optimal trajectory defines an optimal movement of the robot device that respects the safety condition and the movement-related target parameter.
